(19) United States
(12) Patent Application Publication
(10) Pub. No.: US 2026/0277703 A1
(43) Pub. Date: Sep. 17, 2026

(54) BOOSTING PERFORMANCE OF AI/ML HPC WORKLOADS

(71) Applicant: Hewlett Packard Enterprise Development LP, Spring, TX (US)

(72) Inventor: Soumitra Chatterjee, Bangalore (IN)

(21) Appl. No.: 19/235,049

(22) Filed: Jun. 11, 2025

(30) Foreign Application Priority Data
Mar. 11, 2025 (IN) 202541022098

(51) Int. Cl. G06F 9/50; G06F 8/41

(52) U.S. Cl. CPC G06F 9/5083; G06F 8/4441; G06F 9/5016

(57) ABSTRACT

One aspect of the instant disclosure provides a system and method for managing high-performance computing (HPC) workloads. During operation, a workload management node in an HPC cluster may receive a request for executing a job for performing a machine learning task, distribute the job to a plurality of compute nodes based on the request, and configure a respective compute node of the plurality of compute nodes to store machine code associated with a function at a shared storage location. The function is part of the job, and the shared storage location is accessible to the plurality of compute nodes to allow a different compute node to execute the function without compiling source code of the function.

### BACKGROUND

### Field

This disclosure relates to a system and method for improving the execution efficiency of Artificial Intelligence (AI) or Machine Learning (ML) workloads in a High-Performance Computing (HPC) environment.

### Related Art

High-Performance Computing (HPC) plays a crucial role in advancing AI and ML by providing the necessary computational power to process and analyze massive datasets. HPC systems typically consist of a large number of nodes, each equipped with powerful CPUs and GPUs, working in parallel to handle complex calculations and data-intensive tasks. In AI applications, HPC is particularly valuable for training large-scale ML models such as deep neural networks. These models often require processing enormous amounts of data with multiple iterations to adjust weights and parameters to improve the model's accuracy and performance. These processes are computationally intensive and often need to perform numerous operations simultaneously. HPC systems can meet these demands by leveraging parallel processing, where multiple processors work together to manage different aspects of the calculations at the same time. Among various programming languages used for ML tasks, Python has emerged as the dominant one. Therefore, improving Python's performance in HPC environments becomes essential to meeting the ever-increasing demands of AI and ML workloads.

### BRIEF DESCRIPTION OF THE FIGURES

FIG. 1 illustrates an example HPC cluster according to one aspect of the instant disclosure.

FIG. 2 illustrates an example use case for caching compiled functions in a shared directory, according to one aspect of the instant disclosure.

FIG. 3 presents a flowchart illustrating an example process for managing high-performance computing (HPC) workload, according to one aspect of the instant disclosure.

FIG. 4 illustrates an example computer system facilitating high-performance computing (HPC) workload management, according to one aspect of the instant disclosure.

FIG. 5 illustrates a computer-readable medium (CRM) that facilitates high-performance computing (HPC) workload management, according to one aspect of the instant disclosure.

In the figures, like reference numerals refer to the same figure elements.

### DETAILED DESCRIPTION

Python has become the go-to programming language for developing AI and ML models due to a number of factors, including its simplicity and readability, a vast collection of libraries and frameworks specially tailored for ML tasks (e.g., TensorFlow, PyTorch, scikit-learn, etc.), and its flexibility between object-oriented and scripting approaches. However, Python's interpreted nature can lead to slower execution compared to compiled languages like C++. Moreover, many Python interpreter tools use a “Global Interpreter Lock” to ensure that only one thread is allowed to run at a time, which constrains Python's performance in parallel computing scenarios.

Given that approximately 90% of HPC centers are integrating AI/ML methods, and that Python dominates the AI/ML ecosystem with over 42% of Python users working on ML tasks, improving Python's performance in HPC environments is essential to meeting the demands of innovative research and industrial workloads. The convergence of AI/ML with HPC will continue to drive Python's adoption, but its performance limitations in large-scale, distributed systems need to be addressed to unlock its full potential in these environments.

Existing approaches for optimizing Python in an HPC environment may include implementing just-in-time (JIT) compilation (which may compile portions of Python code into machine code at runtime, just before execution) to combine the flexibility of interpretation with the speed of compiled code. In addition, some Python libraries have been optimized through external integration of high-performance languages like C and C++. However, there remains a substantial gap in fully leveraging HPC resources for Python-based applications like AI/ML applications. Some aspects of the instant disclosure provide a system and method for improving the performance of Python-based AI/ML workloads executed on an HPC cluster. More specifically, the HPC system may implement a workload manager that can provide native support for just-in-time compilation to facilitate the reuse of compiled functions across distributed compute nodes in an HPC cluster, leading to reduced runtime of frequently used functions as well as conserved computational resources, energy, and disk space.

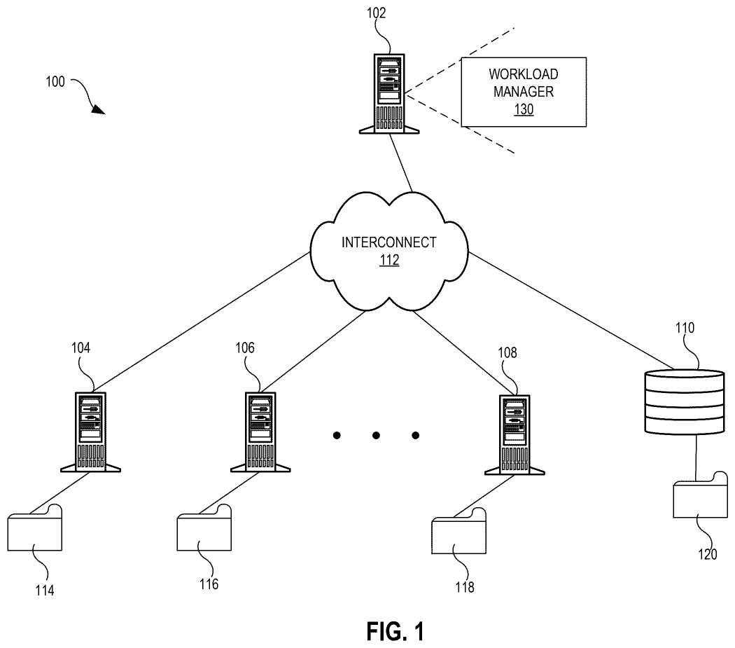

FIG. 1 illustrates an example HPC cluster according to one aspect of the instant disclosure. In FIG. 1, an HPC cluster 100 may include a head node 102, a plurality of compute nodes (e.g., compute nodes 104-108), one or more storage nodes (e.g., storage node 110), and a high-speed interconnect 112.

Head node 102 (also referred to as a management node) may be responsible for managing the entire cluster and can manage job scheduling, resource allocation, and monitoring of the other nodes. Compute nodes are responsible for all the intensive computations that run inside the cluster. Each compute node may include multiple central processing units (CPUs) or graphics processing units (GPUs), which are crucial for parallel processing. Storage nodes (e.g., node 110) may provide shared storage that is accessible to all nodes in the cluster. The shared storage can be in the form of a Network File System (NFS), a parallel file system, or other types of distributed storage. High-speed interconnect 112 allows the various nodes within HPC cluster 100 to communicate with each other. In one example, high-speed interconnect 112 may include Ethernet switches.

As used herein, the term “node” may refer to one or more computing devices configured to emulate one or more, or all, of the functions described herein. As used herein, a “computing device” may be a server, a cluster of servers, a storage array, a computer appliance, a workstation, a desktop computer, a laptop computer, a switch, a router, or any other processing device or equipment including a processing resource. In an example, the node may include a processing resource communicatively coupled to at least one non-transitory computer-readable storage medium including instructions that, when executed by the processing resource, cause the node to undertake certain actions and functionalities as described herein.

Each compute node may include a local file directory for storing data accessible to that compute node only. In the example shown in FIG. 1, compute node 104 may include a local directory 114, compute node 106 may include a local directory 116, and compute node 108 may include a local directory 118. In conventional approaches, when a JIT compiler is used to improve the performance of the interpreted computer program (e.g., a Python program) on one compute node, compiled functions are stored in a default local directory of the compute node, which cannot be accessed by a different compute node. For example, compute nodes 104-108 may perform the task of training a machine learning model, which may involve executing a matrix-multiplication function multiple times. To improve efficiency, compute node 104 may use a JIT compiler (e.g., Numba) to compile the matrix-multiplication function at runtime and cache the compiled code (i.e., the machine code) in local directory 114, such that, when the same matrix-multiplication function is invoked at a later time, the machine code may be loaded from local directory 114 directly without the need for compilation. The use of the JIT compiler and the caching of compiled function can reduce the compilation times of compute node 104. However, other compute nodes invoking the same function cannot benefit from the cached machine code because they cannot access directory 114, which is local to compute node 104.

To improve the performance of the entire cluster, according to some aspects of the instant disclosure, each compute node may be configured to cache compiled functions in a shared directory (e.g., shared directory 120 on storage node 110) to allow access to the compiled code by different compute nodes. In the previous example, compute node 104 may be configured to cache the compiled matrix-multiplication function in shared directory 120. When compute node 106 invokes the same function, instead of compiling the function, compute node 106 may directly access the compiled version of the function (i.e., the machine code) from shared directory 102, assuming that the underlying cache reuse conditions are satisfied. Considering that the same function (e.g., the matrix-multiplication function) may be invoked many times during the training of a machine-learning model, the reduced compilation time at each encounter of the function may significantly improve efficiency. Moreover, all compute nodes may use a single copy of the compiled function, thus reducing the required storage space.

According to some aspects, an HPC workload manager may be used to automatically override the default local cache location for the JIT compilations to shared directory 120. A workload manager may include a specialized software tool designed to manage, schedule, and optimize compute jobs across a computer cluster. In HPC, workload managers are indispensable for ensuring the efficient execution of complex, resource-intensive workloads (e.g., the training or execution of AI/ML models). In some examples, a workload manager 130 may reside on head node 102, as shown in FIG. 1.

Beyond their core functions of scheduling and allocating computational resources, workload managers play a critical role in managing shared storage and configuring execution environments of HPC clusters. By dynamically setting environment variables, they ensure that jobs have seamless access to shared directories, scratch spaces, and other essential resources crucial for smooth data flow. Workload managers also handle key runtime configurations, automatically setting variables that define job-specific information such as allocated compute nodes, job identifiers (IDs), and resource limits. This ensures that applications interact efficiently with the HPC infrastructure, minimizing delays and optimizing resource utilization. Their ability to manage shared environments and orchestrate resources across massive clusters is foundational to maximizing system performance, minimizing idle time, and ensuring fair access for users. In some examples, the workload manager may be executed on head node 102 of HPC cluster 100.

According to some aspects, the workload manager may configure each compute node to cache the JIT-compiled functions by propagating an environment variable related to the cache location. The environment variable may be set globally for all jobs. If the user does not want to include a specific workload or job in the above scheme of shared cache location, the user may use the job submission script to override the global environment variable (e.g., by using a job-specific value of the shared directory). In addition to setting the environment variable, the workload manager may also use a Python attribute value (which may be set during runtime) to specify the path to a shared directory.

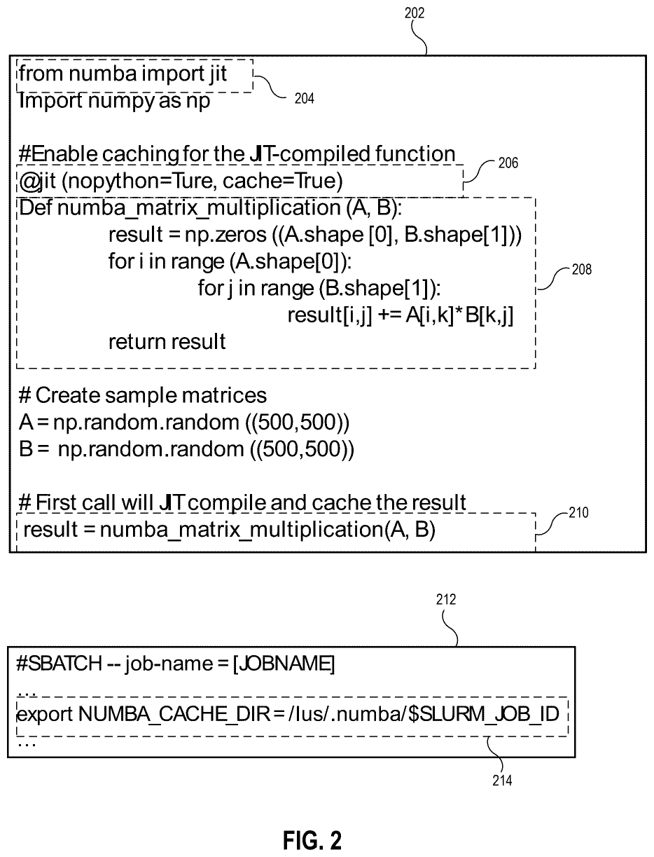

FIG. 2 illustrates an example use case for caching compiled functions in a shared directory, according to one aspect of the instant disclosure. In FIG. 2, code block 202 includes an example function written in an interpreted language. In this example, the function comprises a matrix-multiplication function written in Python. Python code is executed line-by-line by an interpreter, which translates the human-readable source code into machine-understandable instructions in real time. A JIT compiler has been installed in the HPC cluster and may be used to compile the Python code. In the example shown in FIG. 2, the JIT compiler may be Numba, an open-source JIT compiler that translates Python functions to optimized machine code at runtime using the industry-standard LLVM compiler library. Numba-compiled numerical algorithms in Python can approach the speeds of C or FORTRAN. The first line (e.g., code line 204) in code block 202 imports Numba to the Python interpreter, and the second line imports the Python library for numerical computing, NumPy.

Numba provides an @jit decorator, which marks a function for optimization by Numba's JIT compiler. In the example shown in FIG. 2, two keyword-only arguments are passed to the @jit decorator, including “nophthon” and “cache,” as indicated by code line 206. Nopython=True is the default compilation mode of Numba, which generates code that does not access the Python API and produces the highest performance code. “Cache=True” instructs Numba to write the result of the function complication (i.e., the machine code) into a file-based cache. More specifically, Numba's caching mechanism stores the JIT-compiled functions based on the function's source code, signature (e.g., the number and types of the input and output), and environment (e.g., the Python version), thereby allowing multiple cached versions to coexist and reused across multiple executions. The next few lines of code (i.e., lines in block 208) are standard commands for a matrix-multiplication function, and code line 210 calls the matrix-multiplication function. Note that the first time the function is called, the JIT compiler will compile the function and cache the compiled function (i.e., the machine code) at a predetermined cache location.

As discussed previously, in conventional implementations, the compiled function is cached at a default location (e.g., in the user home directory or a local directory on the login node of the cluster). The current compute node (e.g., the compute node executing code block 202) may reuse the compiled function if it is called again. However, the cached version of the Numba-compiled function cannot be reused across multiple invocations of the same function across different matching compute nodes (e.g., nodes satisfying the underlying cache reuse conditions), which may incur an unnecessary additional compilation overhead, even when all the conditions for the cache reuse are satisfied (e.g., identical architecture, matching versions for Python, Numba & other dependencies, etc.).

According to some aspects, to minimize the compilation overhead of Numba for multiple invocations of the same function across multiple compute nodes in an HPC cluster, the workload manager of the HPC cluster may automatically override the default cache location for Numba compilations to a directory shared by all compute nodes in the cluster. In some aspects, a job submission script from the user may specify an algorithm used for deriving the file path to the shared directory storing the machine code. Example algorithms may include using a job-specific parameter (e.g., the job ID or job name) as part of the file path. In the example shown in FIG. 2, the workload manager may be Simple Linux Utility for Resource Management (Slurm), which is an open-source workload manager. Note that Slurm is widely used in supercomputing environments, including about 60% of the TOP 500 supercomputers, due to its scalability, flexibility, and fault tolerance. In FIG. 2, an example Slurm job submission script 212 includes a command line 214 to set up an environment variable (e.g., NUMBA_CACHE_DIR) that points to a shared directory for caching compiled functions of the Python workloads. In this example, it is assumed that/lus points to a shared directory in the cluster, and the name of the base directory may include the job ID. Execution of command line 214 may result in the propagation of the environment variable to each node executing the job.

Moreover, the shared cache location for functions executed in a particular job may be derived such that it is unique to the workload, leveraging the unique job ID assigned to the job when it is submitted to the workload manager queue. In the example shown in FIG. 2, $SLURM_JOB_ID is used to specify a job-specific subdirectory in the shored directory/lus. All Numba-compiled functions within a job may be stored in a directory based on the file path /lus/.numba/$SLURM_JOB_ID. If the workload manager may use Portable Batch System (PBS), $JOB_ID may be used to specify the file path for storing the compiled functions. In another example, the workload manager may use Load Sharing Facility (LSF), and $LSB_JOBID may be used to specify the file path for storing the compiled functions. In addition to the job ID, one may also use the name of the job to derive the path to the shared directory (e.g., $SLURM_JOB_NAME). Upon receiving the job submission script, the workload manager may schedule the execution of the job on one or more compute nodes based on the resource requirement specified in the job submission script and the available resources.

Once the compiled function (e.g., the matrix-multiplication function 208) is cached in the shared directory, any subsequent calling of the same function from any node in the cluster would be directed to the shared directory to load the compiled code if the underlying cache reuse conditions are satisfied. A cached compiled function may be reused if the function's source code, signature (e.g., the number and type of input and output), and executing environment (e.g., the Python version) remain unchanged. When the function is first compiled and cached, the cache remembers the CPU model and the available CPU features during compilation. In some examples, when the function is called on a different compute node, if the CPU model and CPU features do not match exactly, the cached content (e.g., the compiled functions) will not be loaded. Instead, an additional version of the compiled function may be cached for the new combination of the source code, signature, executing environment, CPU model, etc. The additional version may be subsequently reused by other matching nodes (e.g., nodes satisfying the cache reuse conditions) invoking the same function. By automatically defining the shared cache directory for all Python workloads, recompilation of repeatedly executed functions can be avoided even across distributed nodes and users. Thereby, users can benefit from reduced runtime for frequently used functions as well as conserved computational resources, energy, and disk space, as the same compiled machine code is used by multiple users.

In some examples, a user may not wish to have certain workload to cache the compiled functions in the shared file directory. In such a case, a job-specific value of cache directory path (e.g., NUMBA_CACHE_DIR) may be used to override the scheme of the shared cache directory. Alternatively, the cache directory may be defined programmatically using a Python attribute (e.g., numba. config. CACHE_DIR). For example, the workload may include a Python script that specifies the cache location, and each compute node may execute such a script before executing the job. In addition to the per-job configuration, for the same workload (or job), it is also possible to cache a subset of the JIT-compiled functions in the shared cache directory and a different subset of the JIT-compiled functions in a local directory.

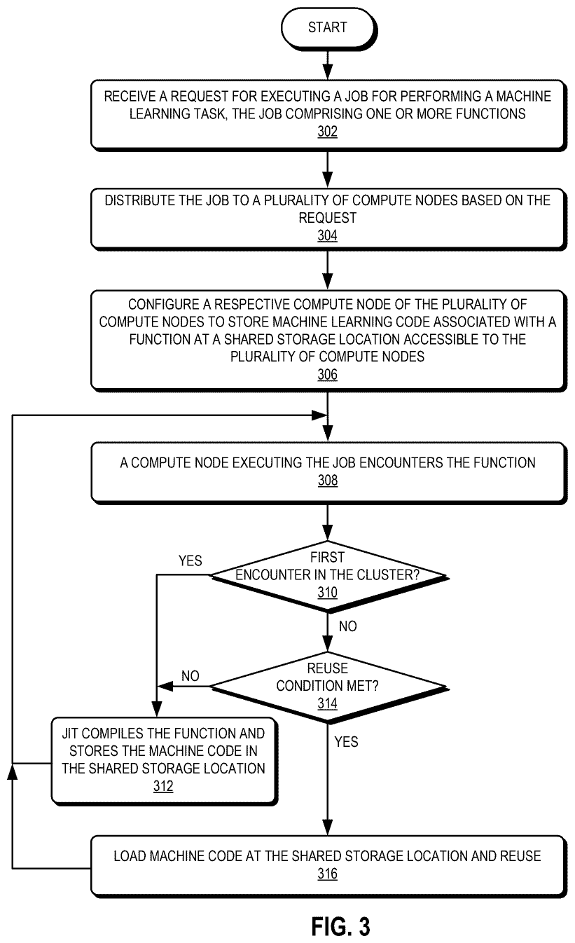

FIG. 3 presents a flowchart illustrating an example process for managing HPC workload, according to one aspect of the instant disclosure. All or any portion of the operations shown in FIG. 3 may be performed, for example, by head node 102 shown in FIG. 1. Although the example process in FIG. 3 shows a specific order for performing certain operations, the process is not limited to such an order. Operations shown in succession in the flowchart may be performed in a different order and may be executed concurrently or with partial concurrence or combinations thereof.

During operation, the head node of an HPC cluster may receive a request for executing a job for performing a machine learning task, the job comprising one or more functions (operation 302). The head node may run a workload manager (e.g., Slurm, PBS, LSF, etc.), and the request for executing the job may be in the form of a job submission script. The job submission script may include resource requests (e.g., the number of nodes and CPUs, the amount of memory, the maximum wait time, etc.) and commands for loading necessary software modules, setting up the job-execution environment, and running the computational task. According to some aspects, the job submission script may include a command line for setting the file directory for caching the JIT-compiled function. For example, the JIT compiler may be Numba, and the command line may set the environment variable NUMBA_CACHE_DIR. In further examples, the file directory may be shared by all nodes in the cluster (i.e., all nodes within the cluster have full access to the file directory).

Machine learning workloads are computationally intensive and often involve many iterative steps, meaning that certain functions (e.g., a matrix multiplication function) may be called many times. Caching the JIT-compiled machine code of the function in a shared directory to facilitate the reuse of the compiled code across different nodes in the cluster may provide significant benefits in performance. According to some aspects, the machine learning task may include a model-training task and/or a hyperparameter tuning task.

The head node may distribute the job to a plurality of compute nodes based on the request (operation 304). More specifically, the workload manager may track available computing resources in the HPC cluster, including nodes, cores, memory, and specialized hardware like GPUs, and dynamically allocate these resources based on job requirements. Jobs submitted by different users may be placed in the job queue, and the workload manager may schedule the execution of the jobs based on the job priority level and submit time.

The head node may configure a respective compute node of the plurality of compute nodes to store machine code associated with a function at a shared storage location accessible to the plurality of compute nodes (operation 306). According to some aspects, the job request may include the request for executing a computer program or code written in an interpreted language (e.g., Python). Each compute node may be preconfigured with a JIT compiler (e.g., Numba). Alternatively, the job request received at the head node may include a command for loading the JIT compiler. The to-be-executed computer code may include at least one function with the @jit decorator, meaning that the first time the function is called, the JIT compiler will compile the function to machine code and store the compiled function at a predetermined location (e.g., a predetermined file directory).

According to some aspects, the JIT-compiled function (i.e., the machine code of the function) may be stored in a file directory accessible to all compute nodes in the cluster. The file path may be derived based on one or more parameters specific to the job, including but not limited to the job ID and the job name. If the workload manager is Slurm, an example file path may be “/lus/.numba/$SLURM_JOB_ID,” where/lus points to a shared directory. The file path may have a different format, as long as it is unique to the workload and points to a shared storage location.

A compute node executing the job may encounter the function (operation 308) and determine whether this is the first encounter in the cluster (operation 310). According to some aspects, executing the job may involve running a Python script. According to further aspects, the Python script may include one or more functions to be compiled by a JIT compiler. In one example, the JIT compiler may be Numba, and the functions may be decorated with @jit. The compute node may determine whether this is the first encounter by checking the predetermined shared storage location to see if the machine code associated with the function is cached. More specifically, the signature of the function may be used as a search key to determine whether the shared storage location stores a corresponding copy of the machine code. The shared storage location may be specified by the user within the job submission script.

If the encounter is the first encounter in the cluster, the JIT compiler may compile the function and store the machine code at the predetermined shared storage location (operation 312) and continues execution of the job (operation 308). If the encounter is not the first encounter in the cluster, the JIT compiler may determine whether the cache-reuse condition is met (operation 314). The cache-reuse condition may be met if the function's source code, signature (e.g., the number and type of input and output), and executing environment (e.g., the Python version, the CPU's model and features, etc.) remain unchanged. The cached machine code for a function may be reused if and only if the cache-reuse condition for that function is met. For example, the cached machine code may be reused for a subsequent function call if the following conditions are met: the function's source code has not been modified since the last compilation; the function's parameters and return type remains unchanged; the runtime environment, including library versions and system configurations, is consistent with the previous execution; and, optionally, the cached machine code is loaded at the same memory address as when it was originally compiled.

If the cache-reuse condition is not satisfied, the JIT compiler may compile the function and store the machine code at the predetermined shared storage location (operation 316), and the compute node continues execution of the job (operation 308). If the cache-reuse condition is satisfied, the machine code at the shared storage location may be loaded and reused (operation 314), and the compute node continues execution of the job (operation 308).

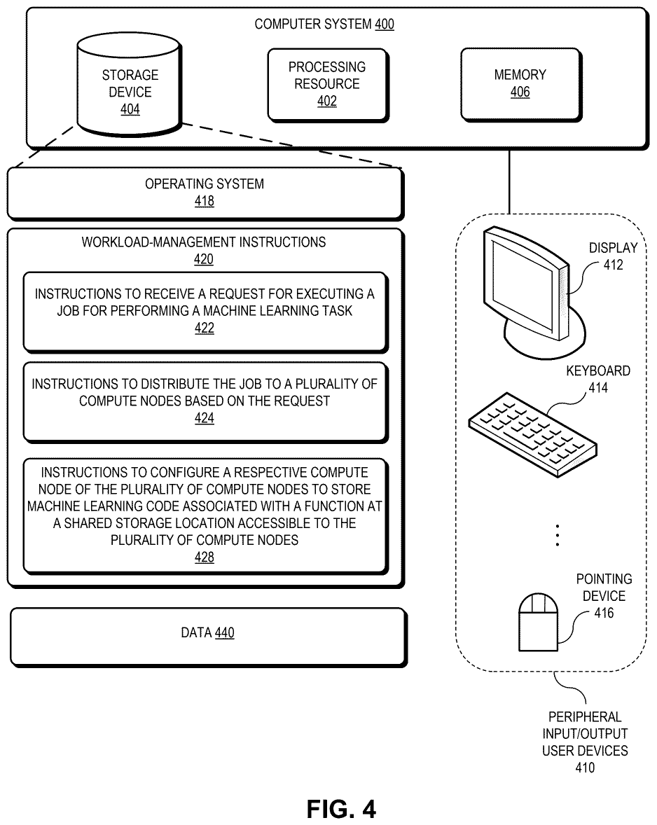

FIG. 4 illustrates an example computer system facilitating HPC workload management, according to one aspect of the instant disclosure. Computer system 400 may include one or more processing resources (e.g., a processing resource 402), one or more storage devices (e.g., a storage device 404), and a memory 406.

A processing resource may include, for example, one processor or multiple processors included in a single computing device or distributed across multiple computing devices. In some examples, the concurrent processes may be executed on a single computing device or multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Computer system 400 can be coupled to peripheral I/O user devices 410 (e.g., a display device 412, a keyboard 414, and a pointing device 416). Storage device 404 includes a non-transitory computer-readable storage medium and stores an operating system 418, workload-management instructions 420, and data 440. Computer system 400 may include fewer or more entities than those shown in FIG. 4. According to some aspects, computer system 400 may be implemented by a dedicated management server (e.g., head node 102 shown in FIG. 1) within a data center.

Workload-management instructions 420 may include instructions, which when executed by computer system 400, can cause computer system 400 to perform methods and/or processes described in this disclosure. Workload-management instructions 420 can be executed at least on processing resource 402.

Workload-management instructions 420 may include instructions 422 to receive a request for executing a job for performing a machine learning task, as described above in relation to operation 302 shown in FIG. 3. The machine learning task may include a model-training task and/or a hyperparameter tuning task. The request may be in the form of a job submission script, which specifies the resources needed for executing the job and includes commands for setting up the execution environment.

Workload-management instructions 420 may include instructions 424 to distribute the job to a plurality of compute nodes based on the request, as described above in relation to operation 304 shown in FIG. 3. More specifically, instructions 424 may include instructions to queue the job in a job queue and instructions for selecting a subset of compute nodes within the cluster based on resources needed for executing the job and the availability of resources in the cluster.

Workload-management instructions 420 may include instructions 426 to configure a respective compute node of the plurality of compute nodes to store machine code associated with a function at a shared storage location, as described above in relation to operation 306 shown in FIG. 3. The function is part of the job and is compiled by a JIT compiler (e.g., Numba). The shared storage location is accessible to the plurality of compute nodes executing the job. Instructions 424 may include instructions to derive a job-specific file path to the shared storage location.

Workload-management instructions 420 may include more instructions than those shown in FIG. 4. For example, workload-management instructions 420 may include instructions to monitor the execution of the job on the plurality of compute nodes.

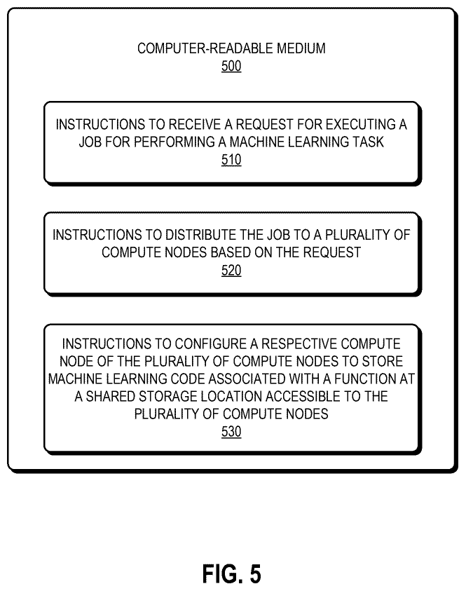

FIG. 5 illustrates a computer-readable medium (CRM) that facilitates HPC workload management, according to one aspect of the instant disclosure. CRM 500 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 500 may store instructions 510 to receive a request for executing a job for performing a machine learning task, as described above in relation to operation 302 shown in FIG. 3; instructions 520 to distribute the job to a plurality of compute nodes based on the request, as described above in relation to operation 304 shown in FIG. 3; and instructions 530 to configure a respective compute node of the plurality of compute nodes to store machine code associated with a function at a shared storage location, as described above in relation to operation 306 shown in FIG. 3.

CRM 500 may include more instructions than those shown in FIG. 5. For example, CRM 500 may include instructions to monitor the execution of the job on the plurality of compute nodes.

In general, aspects of the disclosure provide a solution to improve the performance of workloads in Python, more particularly, machine learning workloads that are computationally intensive and iterative. More specifically, the workload manager of an HPC cluster may automatically configure compute nodes to store JIT-compiled functions in a shared file directory to allow the reuse of the compiled code across different compute nodes and users, thus reducing the compilation overhead. A path to the shared directory may be derived based on job-specific parameters, such as job ID or job name.

One aspect of the instant disclosure provides a system and method for managing high-performance computing (HPC) workloads. During operation, a workload management node in an HPC cluster may receive a request for executing a job for performing a machine learning task, distribute the job to a plurality of compute nodes based on the request, and configure a respective compute node of the plurality of compute nodes to store machine code associated with a function at a shared storage location. The function is part of the job, and the shared storage location is accessible to the plurality of compute nodes to allow a different compute node to execute the function without compiling source code of the function.

In a variation on this aspect, the respective compute node may implement a just-in-time compiler to compile the source code into the machine code.

In a further variation, configuring the respective compute node may include setting, on the compute node, an environment variable that specifies a cache directory to override a default cache directory for storing compiled functions or causing the compute node to execute a script specifying the cache directory before executing the job.

In a variation on this aspect, the workload management node may derive a file directory for storing the machine code based on one or more parameters specific to the job.

In a further variation, the one or more parameters specific to the job may include a job identifier or a job name.

In a further variation, the request for executing the job may include a job submission script specifying an algorithm for deriving a path to the file directory.

In a variation on this aspect, the job may include multiple functions, and the respective compute node may be configured to store machine code associated with a subset of the multiple functions.

One aspect of the instant disclosure provides a high-performance computing (HPC) system. The HPC system may include a plurality of compute nodes and an HPC workload management node comprising a processing resource and a non-transitory machine-readable storage medium comprising instructions executable by the processing resource to: receive a request for executing a job for performing a machine learning task; distribute, based on the request, the job to a plurality of compute nodes; and configure a respective compute node of the plurality of compute nodes to store machine code associated with a function at a shared storage location, the function being part of the job, and the shared storage location being accessible to the plurality of compute nodes to allow a different compute node to execute the function without compiling source code of the function.

One aspect of the instant disclosure provides a non-transitory computer-readable storage medium storing instructions to: receive a request for executing a job for performing a machine learning task; distribute, based on the request, the job to a plurality of compute nodes; and configure a respective compute node of the plurality of compute nodes to store machine code associated with a function at a shared storage location, the function being part of the job, and the shared storage location being accessible to the plurality of compute nodes to allow a different compute node to execute the function without compiling source code of the function.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method for managing high-performance computing (HPC) workloads, the method comprising:
receiving, at a computer, a request for executing a job for performing a machine learning task, the job comprising one or more functions;
distributing, based on the request, the job to a plurality of compute nodes; and
configuring a respective compute node of the plurality of compute nodes to store machine code associated with a function at a shared storage location accessible to the plurality of compute nodes to allow a different compute node to execute the function without compiling source code of the function.

2. The computer-implemented method of claim 1, wherein the respective compute node implements a just-in-time compiler to compile the source code into the machine code.

3. The computer-implemented method of claim 2, wherein configuring the respective compute node comprises:
setting, on the compute node, an environment variable that specifies a cache directory to override a default cache directory for storing compiled functions; or
causing the compute node to execute a script specifying the cache directory before executing the job.

4. The computer-implemented method of claim 1, further comprising deriving a file directory for storing the machine code based on one or more parameters specific to the job.

5. The computer-implemented method of claim 4, wherein the one or more parameters specific to the job comprise:
a job identifier; or
a job name.

6. The computer-implemented method of claim 4, wherein the request for executing the job comprises a job submission script specifying an algorithm for deriving a path to the file directory.

7. The computer-implemented method of claim 1, wherein the job comprises multiple functions, and wherein the respective compute node is configured to store machine code associated with a subset of the multiple functions.

8. A high-performance computing (HPC) system, comprising:
a plurality of compute nodes; and
an HPC workload management node comprising a processing resource and a non-transitory machine-readable storage medium comprising instructions executable by the processing resource to:
receive a request for executing a job for performing a machine learning task, the job comprising one or more functions;
distribute, based on the request, the job to a plurality of compute nodes; and
configure a respective compute node of the plurality of compute nodes to store machine code associated with a function at a shared storage location accessible to the plurality of compute nodes to allow a different compute node to execute the function without compiling source code of the function.

9. The HPC system of claim 8, wherein the respective compute node implements a just-in-time compiler to compile the source code into the machine code.

10. The HPC system of claim 9, wherein, to configure the respective compute node, the instructions are executable by the processing resource to:
set, on the compute node, an environment variable that specifies a cache directory to override a default cache directory for storing compiled functions; or
cause the compute node to execute a script specifying the cache directory before executing the job.

11. The HPC system of claim 8, wherein the instructions are executable by the processing resource to derive a file directory for storing the machine code based on one or more parameters specific to the job.

12. The HPC system of claim 11, wherein the one or more parameters specific to the job comprise:
a job identifier; or
a job name.

13. The HPC system of claim 11, wherein the request for executing the job comprises a job submission script specifying an algorithm for deriving a path to the file directory.

14. The HPC system of claim 8, wherein the job comprises multiple functions, and wherein the respective compute node is configured to store machine code associated with a subset of the multiple functions.

15. A non-transitory computer-readable storage medium storing instructions to:
receive a request for executing a high-performance computing (HPC) job for performing a machine learning task, the job comprising one or more functions;
distribute, based on the request, the HPC job to a plurality of compute nodes; and
configure a respective compute node of the plurality of compute nodes to store machine code associated with a function at a shared storage location accessible to the plurality of compute nodes to allow a different compute node to execute the function without compiling source code of the function.

16. The non-transitory computer-readable storage medium of claim 15, wherein the respective compute node implements a just-in-time compiler to compile the source code into the machine code.

17. The non-transitory computer-readable storage medium of claim 16, wherein, to configure the respective compute node, the instructions are to:
set, on the compute node, an environment variable that specifies a cache directory to override a default cache directory for storing compiled functions; or
cause the compute node to execute a script specifying the cache directory before executing the HPC job.

18. The non-transitory computer-readable storage medium of claim 15, wherein the instructions are to derive a file directory for storing the machine code based on one or more parameters specific to the HPC job.

19. The non-transitory computer-readable storage medium of claim 18, wherein the one or more parameters specific to the HPC job comprise:
a job identifier; or
a job name.

20. The non-transitory computer-readable storage medium of claim 18, wherein the request for executing the HPC job comprises a job submission script specifying an algorithm for deriving a path to the file directory.
